(19) United States
(12) Patent Application Publication
(10) Pub. No.: US 2009/0089139 A1
(43) Pub. Date: Apr. 2, 2009

(54) SCHEDULING PROCESSING TASKS USED IN ACTIVE NETWORK MEASUREMENT

(76) Inventors: Roberto Rojas-Cessa, Brooklyn, NY (US); Nirwan Ansari, Montville, NJ (US); Zhen Qin, Newark, NJ (US)

Correspondence Address: FOLEY & LARDNER LLP, 150 EAST GILMAN STREET, P.O. BOX 1497, MADISON, WI, 53701-1497, US

(21) Appl. No.: 12/201,926

(22) Filed: Aug. 29, 2008

Related U.S. Application Data
(60) Provisional application No. 60/967,046, filed on Aug. 31, 2007.

(51) Int. Cl. G06Q 10/00

(52) U.S. Cl. 705/9

(57) ABSTRACT

A method of scheduling tasks for active network measurement includes identifying a first measurement task for measuring a first network parameter and a second measurement task for measuring a second network parameter. It is determined whether there is a conflict between the first measurement task and the second measurement task. A first execution time of the first measurement task and a second execution time of the second measurement task are also determined. A task schedule is generated based at least in part on the first execution time, the second execution time, and whether there is the conflict between the first measurement task and the second measurement task. The task schedule is further generated based at least in part on a color graph.

### CROSS-REFERENCE TO RELATED APPLICATIONS

The present application claims priority to U.S. Provisional Patent Application No. 60/967,046 filed Aug. 31, 2007, the contents of which are incorporated herein by reference in their entirety.

### BACKGROUND

This background section provides a context for the disclosure. The description herein may include concepts that could be pursued but are not necessarily ones that have been previously conceived or pursued. The description is not intended to be limiting and unless otherwise stated, nothing in this section is admitted as prior art simply by inclusion in this section.

Measurement and monitoring of network traffic and topology is in high demand by Internet service providers (ISPs) as a result of the Internet continuing to utilize a broad array of quality of service (QoS) applications. Active measurement can be used to satisfy the monitoring needs of ISP's. Active measurement can refer to a process by which routers and/or end hosts act as measurement points, and deliberately send probing packets to target destinations with precisely controlled departure times. The target destinations can measure the arrival time of such packets or, in the alternative, may estimate a resulting delay of the packets based on feedback from routers and/or the end hosts. The network information obtained from this active measurement can include parameters such as available bandwidth, capacity, one-way delay, round trip time, jitter, topology, etc. The knowledge of such parameters can be used to facilitate various network administration tasks such as network threat monitoring (e.g., denial-of-service attacks and hot spots), traffic engineering (e.g., QoS routing, re-routing, and link state update), and billing (e.g., where price is based on traffic amount, QoS performance, etc.)

### SUMMARY

This section is intended to provide a broad overview of illustrative embodiments, and is not intended to be limiting. Other principal features and advantages will become apparent to those skilled in the art upon review of the following drawings, the detailed description, and the appended claims.

A method of scheduling tasks for active network measurement is provided. The method includes identifying a first measurement task for measuring a first network parameter and a second measurement task for measuring a second network parameter. It is determined whether there is a conflict between the first measurement task and the second measurement task. A first execution time of the first measurement task and a second execution time of the second measurement task are also determined. A task schedule is generated based at least in part on the first execution time, the second execution time, and whether there is the conflict between the first measurement task and the second measurement task. The task schedule is further generated based at least in part on a color graph.

A measurement device for scheduling tasks for active network measurement is also provided. The measurement device includes a processor and a computer-readable medium operably coupled to the processor. The computer-readable medium has computer-readable instructions stored thereon. Upon execution by the processor, the computer-readable instructions cause the measurement device to determine whether there is a conflict between a first measurement task and a second measurement task. The computer-readable instructions also cause the measurement device to determine a first execution time of the first measurement task and a second execution time of the second measurement task. The computer-readable instructions also cause the measurement device to generate a color graph based at least in part on the first execution time, the second execution time, and whether there is the conflict between the first measurement task and the second measurement task. The computer-readable instructions further cause the measurement device to generate a task schedule including the first measurement task and the second measurement task, wherein the task schedule is based at least in part on the color graph.

A computer-readable medium having computer-readable instructions for scheduling tasks for active network measurement stored thereon is further provided. Upon execution by the processor, the computer-readable instructions cause a computing device to determine whether there is a conflict between a first measurement task and a second measurement task. The computer-readable instructions also cause the computing device to determine a first execution time of the first measurement task and a second execution time of the second measurement task. The computer-readable instructions also cause the computing device to generate a color graph based at least in part on the first execution time, the second execution time, and whether there is the conflict between the first measurement task and the second measurement task. The computer-readable instructions further cause the computing device to generate a task schedule including the first measurement task and the second measurement task based at least in part on the color graph.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a schematic of a network measurement system in accordance with an illustrative embodiment.

FIG. 2 is a visual depiction of a mapping of measurement tasks into graphical vertices in accordance with an illustrative embodiment.

FIG. 3 is a graphical representation of a consumption matrix in accordance with an illustrative embodiment.

FIG. 4(a) is an illustration of a round robin scheduling algorithm with a minimal schedule slot size in accordance with an illustrative embodiment.

FIG. 4(b) is an illustration of a round robin scheduling algorithm with a maximal schedule slot size in accordance with an illustrative embodiment.

FIG. 4(c) is an illustration of a concurrent execution scheduling algorithm in accordance with an illustrative embodiment.

FIG. 4(d) is an illustration of a descending clique coloring scheduling algorithm in accordance with an illustrative embodiment.

FIG. 4(e) is an illustration of an on-demand scheduling algorithm in accordance with an illustrative embodiment.

FIG. 5 is an illustration of a sub-vertex configuration in accordance with an illustrative embodiment.

FIG. 6 is a graphical representation of normalized time space utilization versus conflict probability in accordance with an illustrative embodiment.

FIG. 7 is a graphical representation of normalized time space utilization versus a number of tasks in accordance with an illustrative embodiment.

FIG. 8 is a graphical representation of normalized time space utilization versus a standard deviation of task measurement time in accordance with an illustrative embodiment.

### DETAILED DESCRIPTION

Active measurement tools may compete for network resources as they are carrying out their tasks. Without correct regulation, the competition and resulting conflicts may adversely affect network measurement results. This, in turn, could be falsely interpreted as a network problem and lead to erroneous network administration decisions and/or traffic bursts which may impair the quality of data transmissions. In addition, measurement tasks are often executed as soon as possible such that a network performance state can be timely updated to different quality of service (QoS) management systems (e.g., QoS routers, server hosts, etc.) As the frequency of measurement task execution increases, measurement traffic may also increase, thus raising the possibility of measurement disturbance. Therefore, it is desirable to reduce conflicts between measurement tasks and to minimize the measurement time of all measurement tasks in each measurement cycle (i.e., a set of measurement tasks that are to be performed within a specified period). By reducing conflicts and minimizing measurement times, more active probing of the network can be performed in each measurement cycle.

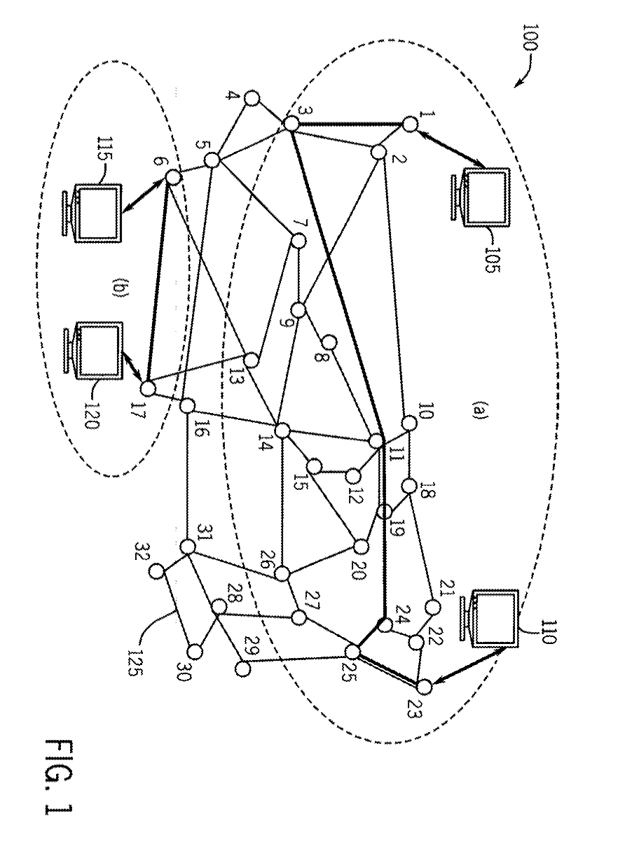

FIG. 1 is a schematic of a network measurement system 100 in accordance with an illustrative embodiment. In alternative embodiments, network measurement system 100 may include additional, fewer, and/or different components. Network measurement system 100 includes a first measurement server 105, a second measurement server 110, a first computing device 115, a second computing device 120, and a plurality of nodes 1-32. The plurality of nodes 1-32 can represent measurement tasks, and links between any of the plurality of nodes 1-32 can be used to represent a conflict relationship between the nodes. For example, a link 125 can indicate that there is a conflict between a node 30 and a node 32. The conflict can indicate that the task corresponding to node 30 and the task corresponding to node 32 cannot be executed simultaneously due to competition for network resources, etc. As such, the conflict relationship can be graphically represented. In one embodiment, network measurement system 100 may also include one or more routers.

In one embodiment, a graph coloring theory can be used to facilitate a measurement-task scheduling algorithm for network measurement system 100. The algorithm can be designed to resolve measurement contention and to provide efficient task processing. For scheduling of pre-computation measurement tasks (or offline tasks), a descending-order clique-based coloring (DCC) algorithm may be used. The DCC algorithm can be used to avoid task contention and conflict, and to significantly improve measurement efficiency. For the scheduling of on-demand tasks (or online tasks), an on-demand scheduling (ODS) algorithm can be used. The ODS algorithm can be used to prevent new on-demand tasks from affecting existing pre-scheduled arrangements and to minimize the waiting time of incoming tasks.

In an illustrative embodiment, active measurements can be launched from a specific measurement server (or measurement point) such as measurement server 105 or measurement server 110. Measurement server 105 and/or measurement server 110 can be connected to one or more routers in the network. Section (a) of FIG. 1 illustrates a measurement of the end-to-end performance between measurement server 105 and measurement server 110. The end-to-end performance can also be measured between measurement server 105 and a router, between measurement server 110 and a router, between measurement server 105 and a node, etc. In one embodiment, measurement tasks, such as Ping, may be implemented at a router. Further, a router or other component may be used to measure the link state between any two neighbors in network measurement system 100. For example, as shown in section (b) of FIG. 1, the link state between computing device 115 and computing device 120 can be measured. Computing device 115 and computing device 120 can be end user computing devices, routers, additional, measurement servers, etc.

Network measurement system 100 can be used to measure a plurality of different QoS parameters such as one-way delay, round-trip delay, available bandwidth, topology, bandwidth capacity, and/or any other parameters known to those of skill in the art. Table I below illustrates representative measurement tools for evaluating representative QoS parameters. In alternative embodiments, any other measurement tools known to those of skill in the art may be used.

TABLE I
Selected measurement tools for QoS parameters.

| QoS parameter | Measurement tool |
|---|---|
| One-way delay | OWAMP |
| Round-trip delay | Ping |
| Available bandwidth | Pipechar or Pathload |
| Topology | Traceroute |
| Bandwidth capacity | Pathchar |

As discussed above, the measurement tasks may be executed periodically in measurement cycles. In each measurement cycle, a measurement task Jⁱ_{x→y} can be denoted as one measurement process executed by an iₜₕ measurement tool. The iₜₕ measurement tool can send probing packets from a measurement point x to a measurement point y. The same measurement task can be processed periodically based at least in part on a length of the measurement cycle.

In one embodiment, a smallest time unit can be referred to as a scheduling (or time) slot, and can be represented by B. Each measurement task can be executed in one or more scheduling slots, depending at least in part on the amount of time it takes for the measurement task to execute. Scheduling efficiency may be improved by having multiple tasks execute during a single scheduling slot as long as there is not a conflict between any of the multiple tasks. Equations 1 and 2 below, which can be used to express illustrative relationships between measurement tasks and execution time of the measurement tasks, are as follows:

B=┌min(T(J))┐ Equation 1

┌T(Jⱼ)┐=αⱼ·B, ∀j∈[1, . . . |J|], Equation 2

where J=(J₁, J₂, . . . Jₘ) is a set of measurement tasks, T(x) is the execution time (or measurement processing time) of a task x, and αⱼ is a positive integer.

As an example, a set of measurement tasks can be represented as J=(J^{L}_{1→2}, J^{L}_{2→1}, J^{L}_{2→3}, . . . , J^{L}_{n-1→n}, J^{L}_{n→n-1}). The set of measurement tasks can be executed within one measurement cycle. A set of measurement points within the network can be represented as N=(1,2, . . . , n), and an index of measurement tools can be represented as L={1,2 . . . , s}. Each measurement task can be represented as a node in a graph, such as the plurality of nodes 1-32 illustrated with reference to FIG. 1. Any two measurement tasks that are connected by a link, such as link 125, may be designated to execute with mutual exclusion on the measurement point or the channel. Measurement tasks designated to execute with mutual exclusion can be said to be adjacent to one other. A graph G (V,E) set up by the nodes and the links can be called a conflict graph.

In an illustrative embodiment, the scheduling of measurement tasks can be enunciated as the arrangement of the nodes in the graph G such that none of the nodes connected with each other are scheduled for simultaneous execution. This problem can be described as a vertex coloring problem. For a conflict graph G(V,E) with vertices V=V(G), each vertex can be assigned a color out of k (e.g., integers 1, . . . , k) colors such that no two adjacent vertices have the same color. In one embodiment, each color can map to one time slot. As such, the color set to be used in the conflict graph can represent a total number of time slots in a measurement cycle.

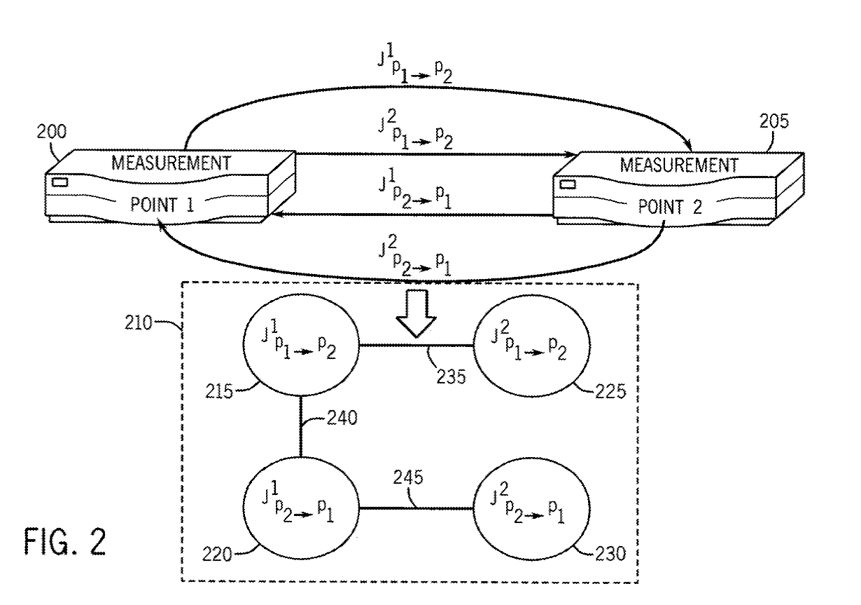

FIG. 2 is a visual depiction of a mapping of measurement tasks into graphical vertices in accordance with an illustrative embodiment. In FIG. 2, a first measurement task J¹ and a second measurement task J² can be executed between a first measurement point 200 and a second measurement point 205 in a duplex fashion. First measurement point 200 and second measurement point 205 can be servers, routers, etc. A task J_{p1→p2}¹ can represent execution of first measurement task J¹ from first measurement point 200 to second measurement point 205, a task J_{p1→p2}² can represent execution of second measurement task J² from first measurement point 200 to second measurement point 205, a task J_{p2→p1}¹ can represent execution of first measurement task J¹ from second measurement point 205 to first measurement point 200, and a task J_{p2→p1}² can represent execution of second measurement task J² from second measurement point 205 to first measurement point 200.

In an illustrative embodiment, task J_{p1→p2}¹ may compete with J_{p1→p2}² for available memory at first measurement point 200. Task J_{p1→p2}¹ may also be in contention with task J_{p2→p1}¹ for a transmission channel. Task J_{p2→p1}¹ may also compete with task J_{p2→p1}² for available memory at second measurement point 205. As illustrated in FIG. 2, task J_{p1→p2}¹, task J_{p1→p2}², task J_{p2→p1}¹, and task J_{p2→p1}² can be represented as a graph 210. Graph 210 has a first node 215 corresponding to task J_{p1→p2}¹, a second node 220 corresponding to task J_{p2→p1}¹, a third node 225 corresponding to task J_{p1→p2}², and a fourth node 230 corresponding to task J_{p2→p1}². Graph 210 also includes a first link 235 representing the competition for memory between task J_{p1→p2}¹ and task J_{p1→p2}², second link 240 representing the competition for the transmission channel between task J_{p1→p2}¹ and task J_{p2→p1}¹, and a third link 245 representing the competition for memory between task J_{p2→p1}¹ and task J_{p2→p1}². In an illustrative embodiment, two colors can be used on graph 210 to represent which tasks can be simultaneously executed. As such, first node 215 and fourth node 230 can be a first color, and second node 220 and third node 225 can be a second color.

One objective of the embodiment of FIG. 2 can be to schedule periodic measurement tasks by pre-computation, and to process on-demand measurement requests for any network topology on the fly. The scheduling complexity can be equivalent to that of the vertex-coloring problem of a conflict graph. The efficiency of the scheduling can be proportional to the number of time slots or colors used in one measurement cycle. Since each measurement task may take different time to complete execution, the measurement tasks can be arranged such that as many measurement tasks are overlapped in each time slot as possible. However, each measurement point may have a limited processing capacity and a limited memory, and each channel may have a limited bandwidth capacity. Hence, the probing packets resulting from execution of measurement tasks may be constrained in a range such that the disturbances to existing data traffic can be minimized. The resource consumption of overlapping measurement tasks can also be expected to operate within system constraints.

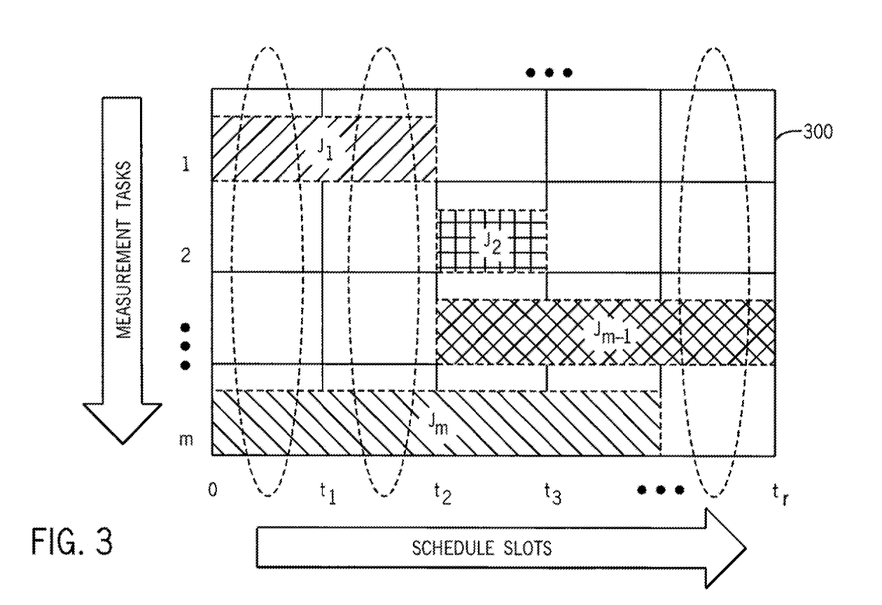

FIG. 3 is a graphical representation of a consumption matrix 300 in accordance with an illustrative embodiment. Columns of consumption matrix 300 represent schedule slots (t₁, t₂, . . . tᵣ) and rows of consumption matrix 300 represent measurement tasks (J₁, J₂, . . . , Jₘ). For different measurement tasks J=(J₁, J₂, . . . , Jₘ) with measurement times T=(T(J₁), T(J₂), . . . , T(Jₘ)), consumption matrix 300 can be an m×r consumption matrix in which each entry represents the network resource consumption of a specific measurement task mapped to that row. In such an embodiment, consumption matrix 300 can minimize the number of the columns r and the total consumption per column

$${\sum }_{i = 1}^{m} {A}_{ij} \leq U ,$$

∀j∈[1,2, . . . r], where U is the constraint (i.e., the limit of the network resource(s) that can be expended by the measurements). As such, consumption matrix 300 can be used to ensure that the sum of the consumption of one or more network resource is less than or equal to the constraint of the one or more network resource at each schedule slot. Total consumption of network resources in each time slot can be represented by the dashed ovals in FIG. 3.

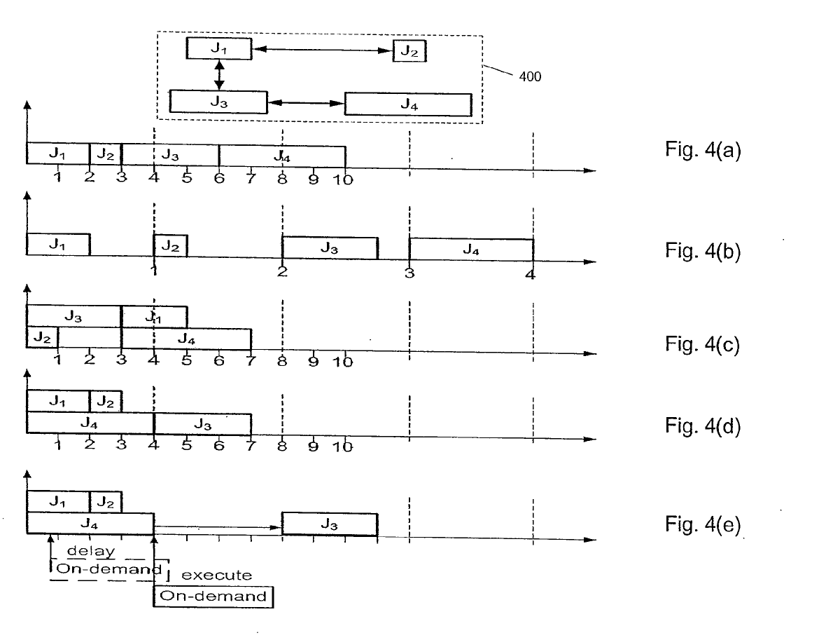

Various scheduling algorithms can be implemented based on the graph coloring techniques described herein. FIGS. 4(a)-4(e) illustrate various scheduling algorithms based on a relationship between tasks J₁, J₂, J₃, and J₄, as depicted in graph 400. One scheduling algorithm can arrange tasks in a fixed order, or a round-robin fashion, as shown in FIG. 4(a) and FIG. 4(b). As such, the measurement tasks can be executed sequentially without overlap in their execution. Sequential execution can be used to ensure that on-demand tasks can be readily inserted for execution. However, this scheduling scheme can result in an increased monitoring time. To increase scheduling efficiency, a scheduling algorithm which allows concurrent execution of measurement tasks can be used.

For pre-computation scheduling, one approach can be to initialize a pending queue to stack all of the measurement tasks to be processed, and creates two lists. A first list can maintain the task release time points and a second list can maintain the finishing times. At each release time, new tasks can be released and examined to determine whether they can be executed without conflict with other on-going measurement tasks. A determination can also be made regarding whether the total measurement load would exceed the resource constraint(s). If a new task cannot be executed at a given release time, the task can be moved to the pending queue for another trial at the next scheduling point. The next scheduling point can be either a subsequent release time or a time when an executing measurement task completes execution. In one embodiment, the task with the shortest execution time can be selected first in the queue. Such a method introduces the possibility of overlapping multiple tasks in each time slot. However, sorting the tasks in the pending queue based solely on their execution time does not account for conflicts between the measurement tasks.

As an example, four measurement tasks J₁, J₂, J₃ and J₄ can have individual execution times of 1, 1, 1, and 4 units, respectively. In addition, measurement tasks J₁, J₂, J₃ can be in conflict with each other, but can be capable of concurrent execution with measurement task J₄. Using a sequential scheduling scheme, the total execution time can be at least 7 time units. However, using a concurrent scheduling scheme in which the longest processing time is first considered (i.e., the 4 units of measurement task J₄), the total execution time can be reduced to 4 units. This is because the remaining three measurement tasks J₁, J₂, and J₃ can execute sequentially while overlapping with measurement task J₄.

In a representative pre-computation scheduling algorithm, the term “clique” can refer to a maximal set of mutually adjacent vertices of a graph G. The term “clique number” can refer to the number of vertices in the largest clique of the graph G denoted as ω(G). The term “degree” can refer to the degree of vertex v in graph G, which can be the number of adjacent vertices of v in G, denoted as d_{G}(v). The maximum degree of graph C can be the maximum number of d(v) in G, denoted as Δ(G).

As described with reference to FIGS. 1 and 2, measurement-task scheduling can be represented using a graph coloring technique. The graph coloring technique can be used along with the execution time of each measurement task and a consumption (or conflict) matrix to minimize scheduling time by maximizing the utilization of ‘time space’ in the conflict matrix. In terms of Equation 2, the measurement task can cover multiple time slots. Since each scheduled time slot can be mapped to a vertex, each task can further be defined as a set of sub-vertices. For a conflict graph G(V,E), each vertex vᵢ that maps a measurement task Jᵢ can be a set of sub-vertices (vⁱ₁, vⁱ₂, . . . , vⁱ_{α}), where α satisfies Equation (2) and i∈[1, . . . , |v|].

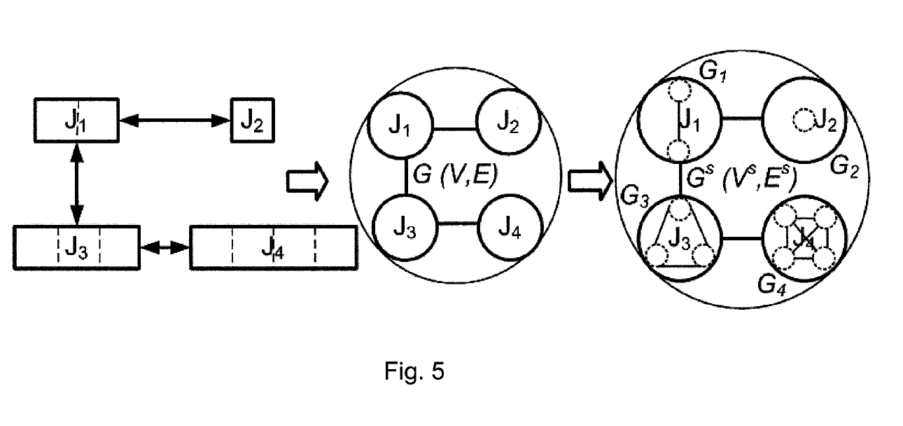

The sub-vertices in a set νᵢ can represent different but consecutive schedule time slots for one measurement task. As such, it can be readily determined whether they conflict mutually, which can be described as a complete sub-graph Gᵢ. FIG. 5 is an illustration of a sub-vertex configuration in accordance with an illustrative embodiment. A sub-graph G₁ corresponds to a measurement task J₁, a sub-graph G₂ corresponds to a measurement task J₂, a sub-graph G₃ corresponds to a measurement task J₃, and a sub-graph G₄ corresponds to a measurement task J₄. Then, graph G can be constructed by sub-vertices and denoted as G^{s}(V^{s},E^{s}), and the clique number of a sub-graph Gᵢ can be the number of vertices in Gᵢ. For example, sub-graph G₁ can have a clique number of 1, sub-graph G₂ can have a clique number of 2, sub-graph G₃ can have a clique number of 3, and sub-graph G₄ can have a clique number of 4.

In an illustrative embodiment, each sub-vertex in the sub-graphs can be colored. In one embodiment, a greedy algorithm can be used to color the sub-vertices with a minimal number of colors. For example, beginning with a fixed sub-vertex enumeration V^{s}=(ν^{s}₁, ν^{s}₂, . . . , ν^{s}|ν^{s}|), the sub-vertices can be considered in turn and each sub-vertex can be colored with the smallest index color within a color set C=(1, . . . , K) that is not reserved to color any of its adjacent sub-vertices. As such, no more than Δ(G^{s})+1 colors may be used to complete the coloring. This upper bound of colors can be lowered. For example, only d_{G}_{^{s}}_{[ν}_{₁}_{^{s}}_{, ν}_{₂}_{^{s}}_{, . . . , ν}_{ᵢ}_{^{s}}_{]}(νᵢ^{s})+1 colors may be utilized to color the current sub-vertex ν^{s}ᵢ because any color to be used by the current sub-vertex does not conflict with that of any uncolored sub-vertices. As such, the uncolored sub-vertices can be removed from the graph G^{s}, and the problem of coloring the current sub-vertex ν^{s}ᵢ in graph G^{s} can be converted to that of coloring ν^{s}ᵢ in graph G^{s}−G^{s} [uncolored], (i.e., G^{s}[ν^{s}₁, ν^{s}₂, . . . , ν^{s}ᵢ]). Hence, only the colored sub-vertices with up to d_{G}_{^{s}}_{[ν}_{₁}_{^{s}}_{, ν}_{₂}_{²}_{, . . . ν}_{₁}_{^{s}}_{]}(ν₁^{s}) colors may be considered.

If the current sub-vertex is connected to all the colored sub-vertices, then the total number of colors used can be d_{G}_{^{s}}_{[ν}_{₁}_{^{s}}_{, ν}_{₂}_{²}_{, . . . ν}_{₁}_{^{s}}_{]}(ν₁^{s})+1. Thus, the total number of colors can be minimized if d_{G}_{^{s}}_{[ν}_{₁}_{^{s}}_{, ν}_{₂}_{²}_{, . . . ν}_{₁}_{^{s}}_{]}(ν₁^{s}) is minimized at each coloring stage. This can be achieved by selecting a particular order of the sub-vertices and by starting with those that have the largest degree. The vertex with the next smallest degree can be colored next, and so on, until reaching the vertex with the smallest degree.

As an example, C_{D} and C_{R} can be the numbers of colors used in coloring the vertices with a descending order degree and with the random order, respectively, and it can be assumed that C_{D}≦C_{R}. The probability that the vertex νᵢ has the same color as its adjacent vertex can be p(νᵢ). As such, p(νᵢ)∝d_{G}(ν₁) because

$$p ( {v}_{i} ) = {\sum }_{j = 1}^{{d}_{G} ( {v}_{i} )} {p}_{j} ( {v}_{i} ) ,$$

where pj(νᵢ) is the probability that the vertex has the same color with a specific neighbor j. For those neighbors which have not been colored yet, pj(νᵢ) is 0, so that

$$p ( {v}_{i} ) = {\sum }_{j = 1}^{{d}_{G} [ v 1 , … vi ] ( {v}_{i} )} {p}_{j} ( {v}_{i} )$$

and p(νᵢ)∝d_{G|ν1, . . . νi]}(ν₁). In addition, d_{G[ν1, . . . νi]}(ν₁)=d_{G}(ν₁)−d_{G[uncolored]}(νᵢ) and the degree of the current vertex among the uncolored parts satisfies d_{G[uncolored]}(ν₁)∝1/C(νᵢ), where C(νᵢ) is the number of colors which have been used before coloring the current vertex. Since

$$C ( {v}_{i} ) ∝ {\sum }_{j = 1}^{i - 1} p ( {v}_{j} )$$

and p(no vertex)=0, it can be verified that Equation 3 below is true when coloring the vertex with the largest degree first. As such, C_{D}≦C_{R}.

$$p ( {v}_{i - 1} ) ↓ ⇒ C ( {v}_{i} ) ↓ ⇒ {d}_{G [ uncolored ]} ( {v}_{i} ) ↑ \\ ⇒ {d}_{G [ v 1 , … vi ]} ( {v}_{i} ) ↓ ⇒ p ( {v}_{i} ) ↓ ⇒ C ( {v}_{i + 1} ) ↓ \qquad Equation 3$$

In accordance with one embodiment, the degree of a sub-vertex in sub-graph Gᵢ is Δ(Gᵢ)+d_{G}(νᵢ), that is, the conflict between the sub-vertices in the same set νᵢ(sub-graph Gᵢ), and the conflict between the vertices in graph G, respectively. Although the complexity of the coloring scheme by the above descending-order degree is not high, the constraint that the sub-vertices in the same set be with consecutive colors can increase the complexity. Hence, in this embodiment, only sub-vertices are enumerated by descending order of Δ(Gᵢ), i.e., the clique number of each sub-graph. This can also be referred to as descending-order clique-based coloring. As shown in FIG. 4(d), the descending-order clique-based coloring scheme first colors measurement task J₄, which has the largest execution time. Measurement task J₃ is run after J₄ due to the conflict between J₃ and J₄ as illustrated by the link measurement tasks J₃ and J₄ in graph 400 The tasks with the third and fourth largest execution times, J₁ and J₂ can be considered and arranged to run concurrently with J₄ because there is no conflict between measurement tasks J₁ and J₄ or between measurement tasks J₂ and J₄. This approach may result in increasing the number of colors, but can enhance the efficiency and reduce the complexity of the scheduling computation. This algorithm can formally be described as follows:

Pre-Computation Scheduling Algorithm (J, T, R, S, U)

| | |
|---|---|
| Input: | measurement task set J, execution time of task T, conflict |
| | matrix R, task consumption S, constraint U. |

Output: color number c, scheduling matrix M.
Initialize c = 0, M = [|J|] [ ] ;
Initialize conflict graph G(V,E) = f(R,J);
Initialize graph with sub-vertices G^{S}(V^{S},E^{S})= f(G,T);
V’ = sort (V, descending order of T(J));
for i = 1: length(V^{S})

Index = c+1;
for j = 1: Index

if S(V’(i)) + S (M(:,j:T(V^{S})) )≦U and (S, M(:,j:T(V^{S}) )) ∉ R

coloring V’(i): M(J(V’(i)),j:T(V^{S})) = S;
c = c + T(V^{S});

else

j = j + k;

% k is the number of time slots of the current scheduled measurement
task.

end

end

In one embodiment, during the execution of the periodic measurement by the pre-computed schedule, an instant and non-periodic measurement task (i.e., on-demand task) may arise with a higher priority than periodic tasks. To simplify the problem, the demand can be sent to a central regulator so that the schedule is controlled by a client/server mode. A goal of the on-demand scheduling can be to execute on-demand requests as soon as possible without disturbing the existing pre-computed schedule table. To achieve this, once an on-demand request arrives, the algorithm can determine whether any running task conflicts with the on-demand request or if the insertion of the on-demand task would violate the constraints of the resources. If there is a conflict or if constraints would be violated, insertion of the on-demand task can be delayed until all conflict tasks are executed and/or until the total consumption is within the constraint. During execution of the on-demand task, periodic tasks may be deferred to let the on-demand measurement exclusively run without competition. This is illustrated with reference to FIG. 4(e), where the on-demand request comes after measurement tasks J₄ and J₁ have started. It can be determined that there is a conflict between the on-demand task and measurement task J₄, but that the total consumption is within the constraint. As such, execution of the on-demand task is delayed until after measurement task J₄ is completed. The on-demand request is executed, and the pre-scheduled task J₃ is deferred until completion of the on-demand task. Alternatively, one or more tasks may be allowed to run concurrently with the on-demand task if there are no conflicts and if the total consumption is within the constraint.

As noted above, FIG. 4(a) illustrates a round robin scheduling algorithm with a minimal schedule slot size (RRI) in accordance with an illustrative embodiment. In FIG. 4(a), the time slot is set to the smallest value of the execution time of the tasks, B=min(T(J)). In this way, the total measurement time can be saved to some extent because the tasks are executed sequentially with small intervals between tasks. FIG. 4(b) illustrates a round robin scheduling algorithm with a maximal slot size (RRM) in accordance with an illustrative embodiment. In FIG. 4(b), the time slot is set to the largest value of the execution time of the tasks, B=max(T(J)). The algorithm of FIG. 4(b) results in a longer time for all measurement tasks in each cycle as compared to the algorithm of FIG. 4(a) because of the idle time interval between consecutive tasks. However, the algorithm of FIG. 4(b) allows each task to be allocated with the same length of time such that the schedule can be implemented with less complexity than that of FIG. 4(a).

FIG. 4(c) illustrates a descending degree coloring (DDC) scheduling algorithm in accordance with an illustrative embodiment. The DDC algorithm can utilize a conflict graph G, but may not consider sub-vertices in each vertex (i.e., may not consider the execution time of each task). The DDC algorithm can choose the tasks by the descending order of the degree of each vertex vi in graph G: d_{G}(νᵢ). To keep the complexity of this scheme within an acceptable level, the schedule slot size can be set to the largest value of the execution time as described above with reference to FIG. 4(b). As described above, FIG. 4(d) illustrates a descending clique coloring (DCC) scheduling algorithm in accordance with an illustrative embodiment.

As an example, a measurement can be comprised of six periodic active measurement tasks with execution time units (1, 2, 4, 6, 8, 10), respectively. For purposes of simplification, it can be assumed that there is no consumption constraint (i.e., that U is infinite). The conflict probability, which represents the probability of the existence of the edge between any two vertices, can be changed from 0 to 1 with increments of 0.2. The conflict probability of 0 implies that there is no edge between vertices. With conflict probability of 1, the graph becomes a complete graph. The normalized time space utilization as defined in Equation 4 below can be used to estimate the efficiency of the scheduling algorithm. Equation 4 is as follows:

$$\begin{matrix}{R}_{n} = \frac{Utiliaztion of actual scheduling}{Utilization when all tasks overlapped} \\ = \frac{{\sum }_{i = 1}^{m} T ( {J}_{i} ) / r \cdot m}{{\sum }_{i = 1}^{m} T ( {J}_{i} ) / max ( T ( J ) \cdot m} \\ = \frac{max ( T ( J )}{r} ,\end{matrix} \qquad Equation 4$$

where r is the number of time slots used for all measurements, m is the number of measurement tasks, and max(T(J)) is the maximum execution time of the measurement tasks. For example, Rₙ of the schedule shown in FIG. 3 can be 4/5=0.8.

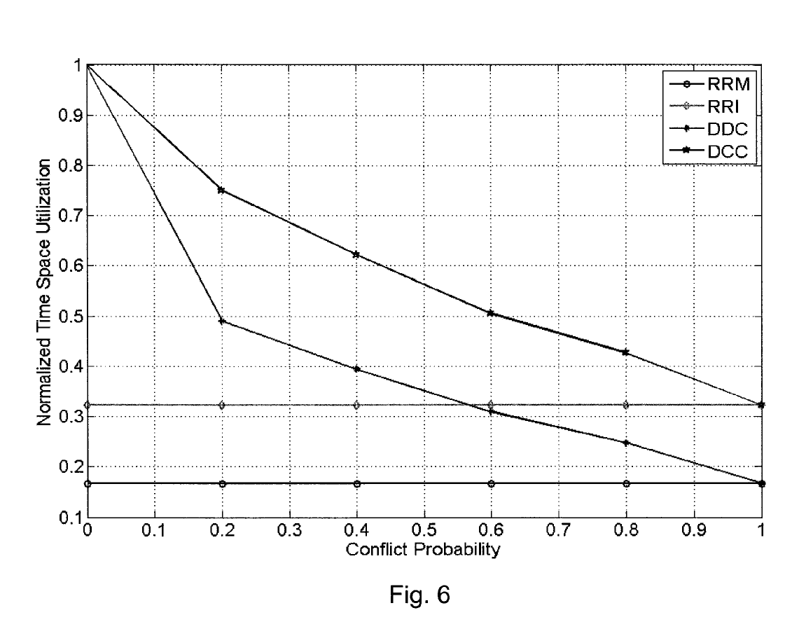

FIG. 6 is a graphical representation of normalized time space utilization versus conflict probability in accordance with an illustrative embodiment. From the simulation results shown in FIG. 6, it can be seen that an embodiment of the proposed DCC algorithm achieves the highest normalized time space utilization. Both round-robin algorithms have constant utilization because they continually fully occupy one row in the consumption space without any overlapping. Therefore, the utilization is inversely proportional to the number of measurement tasks to be scheduled. Also, as the conflict probability increases, the efficiency of non-round-robin scheduling algorithms can decrease because the probability of concurrent executions decreases. In the extreme case, in a graph full of conflicts, DCC and DDC algorithms converge to a round-robin scheduling as all the tasks are to be sequentially scheduled without any overlap.

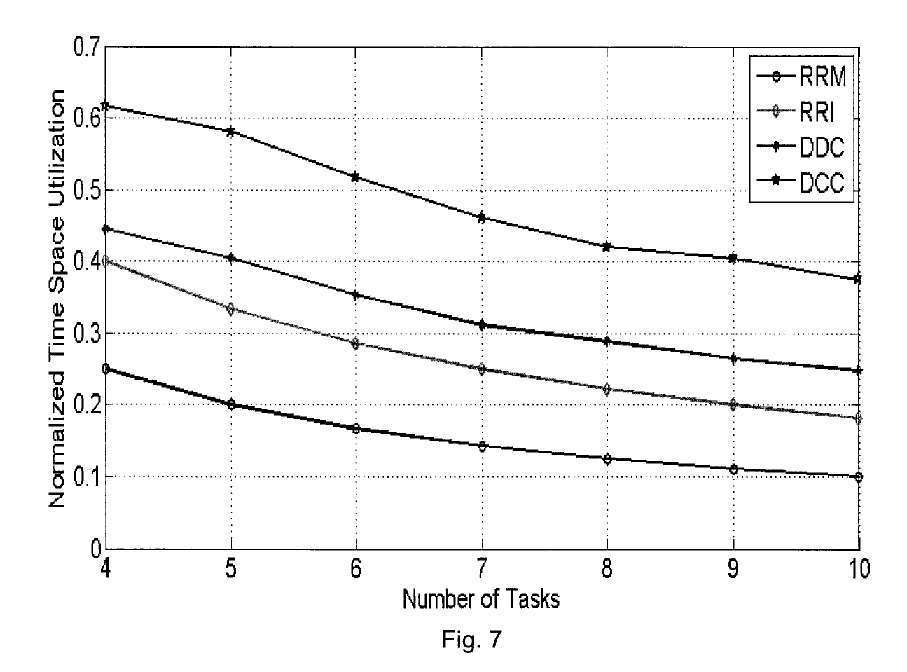

In another example, the number of pre-scheduled measurement tasks can be changed from 4 to 10. The difference of the execution time between two consecutive tasks in the set of measurement tasks is 1, i.e., from T(J)=(1, 2, 3, 4) to T(J)=(1,2,3,4,5,6,7,8,9,10). FIG. 7 is a graphical representation of normalized time space utilization versus a number of tasks in accordance with an illustrative embodiment. FIG. 7 shows that DCC achieves the best time space utilization among all algorithms. In addition, the time space utilization decreases as the number of tasks increases. This occurs in a larger number of tasks, as the conflict probability between tasks increases.

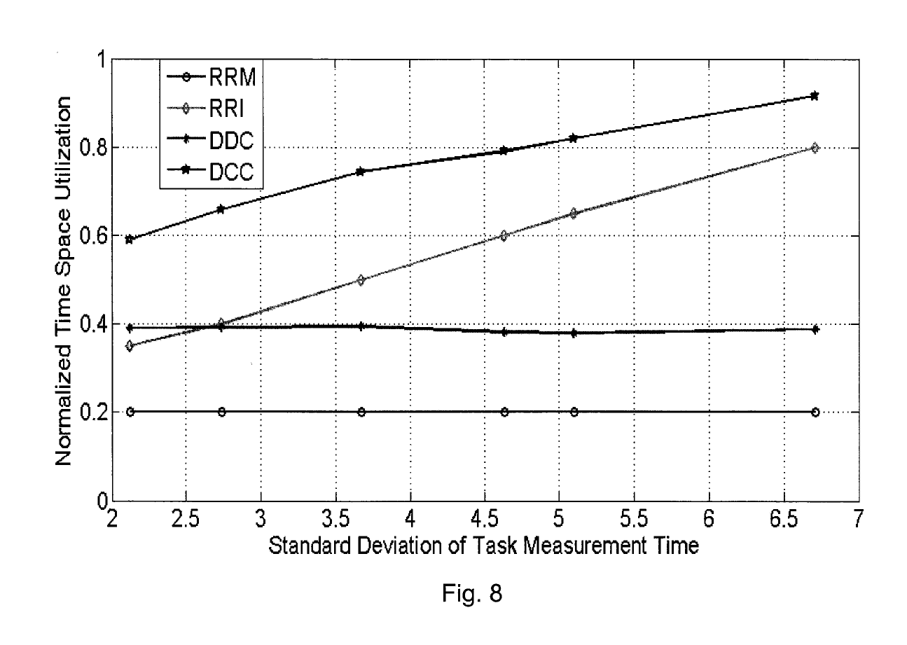

In another example, the execution time of five measurement tasks can be changed, while keeping the mean execution time as 4, as delineated in FIG. 8. FIG. 8 is a graphical representation of normalized time space utilization versus a standard deviation of task measurement time in accordance with an illustrative embodiment. It is shown that the normalized time utilization of the scheduling with minimal time slot (RRI and DCC) increases as the variance of the measurement time increases, but that of the algorithm with maximal slot size (RRM and DDC) does not exhibit notable changes. The reason is that RRM and DDC fix the length of each time slot as the largest execution time of the tasks, so that the increase in the variance of the execution time introduces more idle time between those tasks whose execution time is less than max(T(J)). The increase of the utilization of RRI and DCC can be due to the fact that the numerator T(J) becomes larger when the variance of the execution time of tasks becomes larger. The DCC algorithm obtains the best time space utilization.

In a representative embodiment, the scheduling of the network measurement tasks can be modeled using a graph coloring technique. Both pre-computed (offline) scheduling and the on-demand (online) scheduling algorithms can be addressed in the modeling. A descending-order clique-based task scheduling algorithm can be used to solve the measurement task scheduling problem.

In one embodiment, the greedy algorithm can be used to color the vertices in a graph by a descending order of the degree. Use of the greedy algorithm can result in a relatively small number of colors with low complexity. Hence, the algorithm schedules the tasks in terms of the descending order of the clique in the mapped conflict graph. The proposed approach has been demonstrated to achieve a great improvement on time efficiency and load balancing for measurement-task scheduling under various measurement scenarios.

The presently disclosed systems and methods offer significant advantages over existing scheduling techniques. The advantageous properties and/or characteristics of the disclosed method include, but are not limited to, effectiveness, robustness, and simplicity in implementation. The scheduling methodology can be used to optimize network state computation, improve utilization of storage and channel resources, and shorten measurement time. In accordance with at least one embodiment, a methodology schedules different measurement tasks such that network resources are not exhausted. The network measurement tasks can be modeled as a graph with contention between any two tasks considered as a link there between. In at least one embodiment, each node can be represented as a set of sub-nodes where each sub-node can map to a time unit. For pre-computed offline tasks, priority may be decided by the descending-order of clique number in each set with clique being defined as a maximal set of mutually adjacent vertices on the graph. It can be shown that the number of time units used in various disclosed embodiments will be smaller than that of other existing methods. The scheduling algorithms disclosed herein can also set a resource consumption threshold to constrain the number of parallel tasks executed, to prevent the exceeding of network resources, and to minimize expense. Scheduling on-demand tasks can be implemented by giving the on-demand tasks a priority over offline tasks. In one embodiment, currently executing offline tasks may be allowed complete execution prior to the execution of an on-demand task.

The above described embodiments may be implemented within the context of methods, devices, systems, instructions stored on computer readable media, and computer program processes. As such, it is contemplated that some of the steps discussed herein as methods, algorithms and/or software processes may be implemented within hardware (e.g., circuitry that cooperates with a processor to perform various steps), software or a combination of hardware and software. The embodiments may be implemented as a computer program product wherein computer instructions, when processed by a computer, adapt the operation of the computer such that the methods and/or techniques of the present invention are invoked or otherwise provided.

Instructions for invoking the methods may be stored in fixed or removable media and/or stored within a working memory or mass storage device associated with a computing device operating according to the instructions. A computing device including a processor, memory, and input/output means may be used to process software instructions, store software instructions and/or propagate software instructions to or from a communications channel, storage device or other computer/system.

An attempt has been made to disclose all embodiments and applications of the disclosed subject matter that could be reasonably foreseen. However, there may be unforeseeable, insubstantial modifications that remain as equivalents. While the representative embodiments have been described in conjunction with specific, illustrative embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

What is claimed is:

1. A method of scheduling tasks for active network measurement, the method comprising:
identifying a first measurement task for measuring a first network parameter and a second measurement task for measuring a second network parameter;
determining whether there is a conflict between the first measurement task and the second measurement task;
determining a first execution time of the first measurement task and a second execution time of the second measurement task; and
generating a task schedule based at least in part on the first execution time, the second execution time, and whether there is the conflict between the first measurement task and the second measurement task, wherein the task schedule is generated based at least in part on a color graph.

2. The method of claim 1, wherein the color graph comprises a first node corresponding at least in part to the first measurement task and a second node corresponding at least in part to the second measurement task, wherein the first node and the second node are connected by a link if it is determined that there is the conflict between the first measurement task and the second measurement task.

3. The method of claim 2, wherein the first node is a first color and the second node is a second color if it is determined that there is the conflict between the first measurement task and the second measurement task.

4. The method of claim 3, wherein the first color corresponds to a first time slot of the task schedule and the second color corresponds to a second time slot of the task schedule.

5. The method of claim 3, wherein the first color corresponds to a first color reference in a color set and the second color corresponds to a second color reference in the color set.

6. The method of claim 1, wherein the color graph comprises a first node corresponding at least in part to the first measurement task, and further wherein the first node includes a plurality of sub-vertices, wherein each sub-vertex of the plurality of sub-vertices corresponds to a time slot during which the first measurement task is to execute.

7. The method of claim 6, further comprising assigning a first color to a first sub-vertex of the plurality of sub-vertices and a second color to a second sub-vertex of the plurality of sub-vertices.

8. The method of claim 7, wherein the first color is assigned based at least in part on a degree of the first node.

9. The method of claim 7, wherein the first color is assigned using a greedy algorithm.

10. The method of claim 1, wherein the conflict is based at least in part on utilization of a network resource by the first measurement task and the second measurement task.

11. The method of claim 10, further comprising using a consumption matrix for determining whether there is the conflict between the first measurement task and the second measurement task.

12. The method of claim 1, further comprising:
receiving a request to execute an on-demand task within the task schedule; and
executing the on-demand task upon completion of a currently executing task.

13. The method of claim 12, further comprising delaying execution of the second measurement task until completion of execution of the on-demand task.

14. A measurement device for scheduling tasks for active network measurement, the device comprising:
a processor; and
a computer-readable medium operably coupled to the processor and having computer-readable instructions stored thereon, wherein, upon execution by the processor, the computer-readable instructions cause the measurement device to
determine whether there is a conflict between a first measurement task and a second measurement task;
determine a first execution time of the first measurement task and a second execution time of the second measurement task;
generate a color graph based at least in part on the first execution time, the second execution time, and whether there is the conflict between the first measurement task and the second measurement task; and
generate a task schedule including the first measurement task and the second measurement task, wherein the task schedule is generated based at least in part on the color graph.

15. The measurement device of claim 14, wherein the computer-readable instructions further cause the measurement device to determine a response consumption threshold based at least in part on available network resources, wherein the task schedule is further based at least in part on the response consumption threshold.

16. The measurement device of claim 14, wherein the computer-readable instructions further cause the measurement device to:
represent the first measurement task as a first node in the color graph and the second measurement task as a second node in the color graph;
represent the first node as a first set of sub-vertices, wherein each sub-vertex in the first set of sub-vertices corresponds to one or more time slot of the task schedule; and
assign a color to one or more sub-vertex in the first set of sub-vertices, wherein the color corresponds at least in part to an order of execution.

17. The measurement device of claim 14, wherein the conflict is based at least in part on utilization of a network resource by the first measurement task and the second measurement task.

18. A computer-readable medium having computer-readable instructions for scheduling tasks for active network measurement stored thereon, wherein, upon execution by a processor, the computer-readable instructions cause a computing device to
determine whether there is a conflict between a first measurement task and a second measurement task;
determine a first execution time of the first measurement task and a second execution time of the second measurement task;
generate a color graph based at least in part on the first execution time, the second execution time, and whether there is the conflict between the first measurement task and the second measurement task; and
generate a task schedule including the first measurement task and the second measurement task based at least in part on the color graph.

19. The computer-readable medium of claim 18, wherein the first measurement task is configured to measure a quality of service (QoS) parameter.

20. The computer-readable medium of claim 19, wherein the QoS parameter is a one-way delay, a round-trip delay, an available bandwidth, a topology, or a bandwidth capacity.
